(19) United States
(12) Patent Application Publication
(10) Pub. No.: US 2009/0094336 A1
(43) Pub. Date: Apr. 9, 2009

(54) Method and Apparatus for Automated Monitoring of System Status

(75) Inventors: Louis D. Echevarria, Tucson, AZ (US); Andrew G. Hourselt, Tucson, AZ (US); Stefan Lehmann, Tucson, AZ (US); Richard A. Welp, Tucson, AZ (US)

Correspondence Address: HAMILTON & TERRILE, LLP;IBM Tucson, P.O. BOX 203518, AUSTIN, TX, 78720, US

(73) Assignee: International Business Machines Corporation, Armonk, NY (US)

(21) Appl. No.: 11/868,287

(22) Filed: Oct. 5, 2007

(51) Int. Cl. G06F 15/173; G06F 15/16

(52) U.S. Cl. 709/206; 709/224

(57) ABSTRACT

A method, apparatus and computer program code which monitors a group of networked computers by notifying a central apparatus or database of the current state of each of the computers. The monitoring is achieved through software and hardware which obtains the state of each of the networked computers, determines if a new computer has been connected to the network, sets a state for each new computer and determines if any one of the networked computers has not notified the database of its current state within a prescribed interval of time. The hardware and software also determines if any one of the networked computers is in an inactive state, if any one of the networked computers has changed its state to inactive and updates the database to reflect the current state of each of the networked computers. A list of users is notified of the state of each computer, along with the reason for any change in state of each computer. Network intelligence and outside database resources are used to provide information concerning the reason for any change in state of each of the computers.

### FIELD OF THE INVENTION

The invention relates to the automated monitoring of the status of computer systems on a network through a central apparatus, and to detecting and evaluating errors for such computer systems in particular.

### BACKGROUND OF THE INVENTION

In the past enterprise computer networks were primarily mainframes with terminals at remote locations. The network manager had complete control over the network and processing as it was performed at the mainframe in these systems. Now, personal computers (PCs) provide major processing power replacing terminals on the desktop and are most often tied into networks. This has presented some challenges in maintaining operation of such computers and networks. Unlike mainframe managers, the manager of a PC network has limited control over and reduced information concerning the respective client computers on the network. This has been a particularly increasing problem as the number of computers on networks has increased, at times numbering over 10,000 client PCs on a single network.

With personal computers replacing terminals on a network, far more can go wrong that is outside the network manager's knowledge or control. This flexibility and power is valuable to the end user but limits the ability of the network manager to perform and control network maintenance and support. Network managers have less information available and on hand when maintaining a remote client PC network which is regularly unattended. It has become more difficult to manage and control such PC networks as personal computer complexity and power increases. Moreover, clients are becoming increasingly dependant on their systems and are less tolerant of downtime. Compounding these issues, today's powerful systems are difficult for most users to manage or repair when abnormal operation such as a fault, a system interruption or another error occurs.

Accordingly a method and apparatus to track the status or state of an increasing number of networked client PCs has become necessary. It would be beneficial to automate such tracking and provide additional information concerning the network addition, connection status, activity status, error status and test status of individual client PCs on a network. It would also be beneficial to improve the knowledge base of such networked PC clients. This will improve response time of personnel responsible for servicing a particular networked PC and will improve the ability of service personnel to detect and evaluate possible errors and state changes for the registered PC clients.

In addition, it would be beneficial to manage such a network and its individual client PCs from a central apparatus or database, use information gathered through remote databases as well as from common conditions of individual PCs on the network, and provide automatic notification to a variety of users in specific subsets on a PC by PC basis. By automating an apparatus, method and computer program to detect an individual machine's status or state using a certain set of criteria, we can effectively and efficiently manage the vast number of computers on a large and growing network.

### SUMMARY OF THE INVENTION

The present invention provides a method, apparatus and computer program product for monitoring a group of attached devices or machines such as client computers or personal computers (computers, PCs or machines including but not limited to tape drives, disk subsystems and similar storage devices) on a network. Monitoring is achieved through notifying a central database of the current state of each of the computers, machines and the like coupled to the database through the network. The method and apparatus of the present invention includes software and hardware for obtaining the status or state of each of the networked computers or machines, determining if a new computer has been connected to the network, setting a state for each new computer and determining if the current state of any one of the plurality of computers has not been obtained within a prescribed interval of time or if any one of the networked computers has not notified the central database of its current state within a prescribed interval of time. The method and apparatus includes hardware and software for determining if any one of the networked computers is in an inactive state, determining if any one of the networked computers has changed its state to inactive and updating the central database to reflect the current state of each of the networked computers. A list of users to be notified of the state of each PC, along with the reason for any change in state of each computer, is compiled from the data in the central database and can be sent automatically to each of the users on the list.

Each of the computers on the network can send a signal to the database at a predetermined time interval and this signal is used by the database to detect when one or more of the networked computers is not operating or not operating properly. If one or more of the PCs has not notified the central database of its current state within a prescribed period of time, the method and apparatus of the present invention can adapt or vary the prescribed period of time to allow for a longer period of time or a shorter period of time as required by the networked PC. The system of the present invention will then update the central database and use either the longer period of time or the shorter period of time as a new prescribed interval for determining if any one of the networked computers has not notified the central database of its current state.

The method, apparatus and computer program product of the present invention will determine the reason for any change in state of each of the networked computers and send an automated alert to a list of users. This automated alert can take the form of an automated formatted email to said list of users. The list of users can be managed to provide a subset of the networked computers and a subset of users from the list of users to notify through the automated formatted email.

The method, apparatus and computer code of the present invention also includes the ability to check an outside database or compare the similarities of a subset of computers on the network to determine the reason for any change in state of one or more of computers on the network. The step of checking an outside database to determine a reason for a change can also be provided through comparing one of the computers on the network to another networked computer to assist in determining the reason for any change in state or status of any computer or group of computers on the network.

### BRIEF DESCRIPTION OF THE DRAWINGS

Presently preferred implementations for the invention will now be described in detail with reference to the drawings wherein:

FIG. 1 illustrates a block diagram of a network arrangement suitable for implementation of the invention;

FIG. 2 illustrates a flow diagram of an exemplary embodiment of a method, apparatus and computer code including the principles of the present invention; and

FIG. 3 illustrates a flow diagram of an exemplary embodiment of a method, apparatus and computer code including the principles of the present invention.

### DESCRIPTION OF THE PREFERRED EMBODIMENTS

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

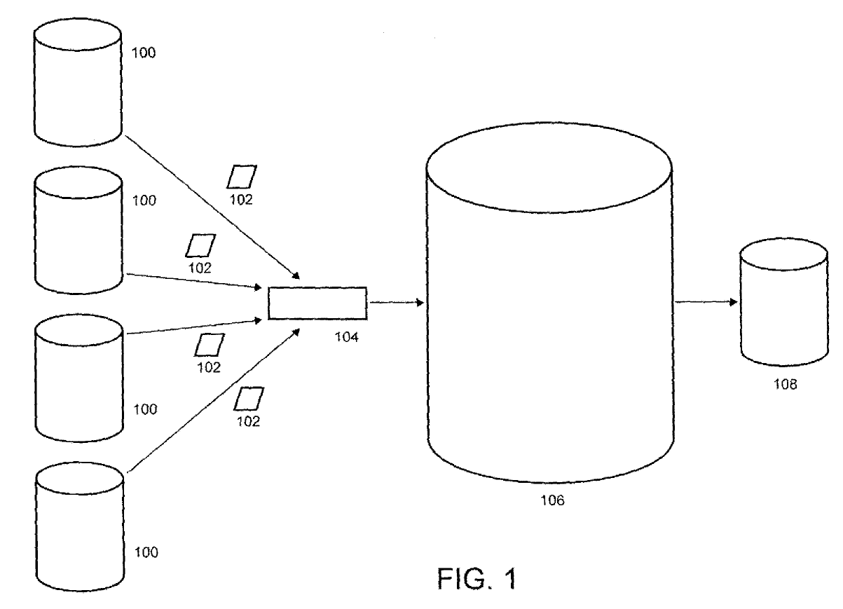

Monitoring the status of a group of attached devices or machines such as client computers, personal computers or storage devices, including but not limited to tape subsystems, disk subsystems and the like, will identify computers, machines or devices that have not reported or called home over the network for any number of reasons. In addition, such monitoring will detect and evaluate errors for such computers, machines or devices. By routinely monitoring the status of the networked machines, the present invention will reduce the response time to remedy the inactivity, error or other fault by informing the correct individuals about the situation. Referring to FIG. 1, monitoring and evaluating the status of a group of networked machines 100 in the field is achieved through monitoring data packages 102 transmitted through a communication device 104 to a network server 106. Network server 106 houses a database 108 which is capable of storing all of the transmitted data packages 102. The last known communication between the networked machines 100 and database 108 can be compared and evaluated for state or status changes on a machine by machine basis. Such monitoring and comparison provides detection and evaluation of possible unexpected inactivity, errors or other faults for the registered or associated machines on the network.

Each data package 102 sent can be considered a call home instance which provides information about the status or state of one or more machines 100 on the network. A call home instance occurs when a machine or group of machines sends a set of data packages 102 to a central apparatus or database 108 to be collected, parsed, and stored. One or more of three types of call home data packages 102 are transmitted over the network to monitor system status of one or more PCs on the network and implement the present invention—a heartbeat data package, an error initiated data package, and a test data package.

A heartbeat data package is sent over a specific time interval to report that the machine or group of machines 100 is performing properly and that it is still connected to the network. A heartbeat data package is a sequence of messages which are sent by a machine or group of machines 100 to a receiving source such as a database 108 or the like. The receiving database 108 includes an interface or computer code to measure the time interval between receiving successive heartbeat data packages from a machine or a group of machines 100. If database 108 does not receive a heartbeat data package prior to the expiration of a predetermined length of time, then the machine or group of machines is suspected of not being connected to the network. One way to determine if a machine has not called home in a given amount of time is to look at the dates of each machine's last call home, or query the database for all of the machines that have not called home over a given period of time. It is the regularity or the specific timing of the report of healthy data and the measurability thereof that allows the method and apparatus of the present invention to infer that there is a problem with a given machine. This problem can be inferred due to the regularity of the expected data package 102 even with no direct connection, indication or report of a problem from a given machine.

An error initiated data package is sent to determine if one of many errors occurs on one or more machines 100. Upon initiation of an error data package, the machines 100 collect the status of all of the appropriate devices and send a response which is collected, parsed and stored within database 108 for use by support personnel. This will allow the support personnel to evaluate the problem remotely and choose the correct maintenance action.

A test data package is initiated and sent by a computer engineer or other network maintenance personnel to ensure that a machine or a group of machines 100 is successfully connected to the network and that all of the features of the machine or the group are performing correctly. The test data package collects the status of all of the polled machines 100 and their respective devices and sends a response which is received, parsed and stored within database 108 for use by the system of the present invention to inform support personnel of any errors or other faults on any of the network machines 100. This response may indicate a change in status of one or more machines 100 which is used to report any problems with any machine 100 on the network.

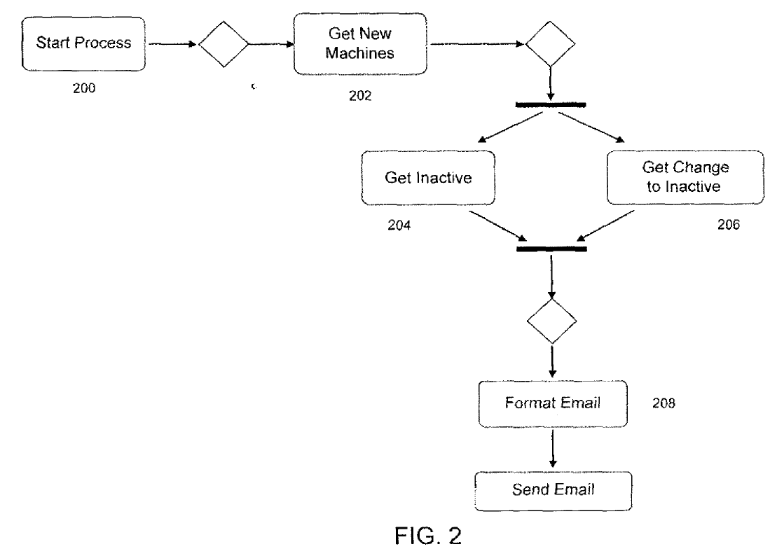

Referring to FIG. 2, the process of monitoring, detecting and evaluating the errors reported by the group of networked computers 100 starts by initialization at step 200. The process then queries the database 108 at step 202 by retrieving the data reported to the database 108 concerning new machines. Specifically, it is determined if any new machine 100 has been added to the network since the last query. If so, a temporary table of new machines added is created for use in a later report. The process then queries the database 108 to determine which machines are inactive or past a predetermined heartbeat period at step 204. At step 206, the process determines which machines have changed to an inactive state, which machines have missed their heartbeat period and are currently listed as active (as compared to the last time the process was run) as ascertained by one or more of the data packages described above. Upon determining the current state of each machine on the network, database 108 is updated to reflect the current state of each machine as verified by the most recent data package sent by the system. The heartbeat reporting time interval is initially set for each monitored machine on the network based on a regular reporting time interval. This regular reporting time interval is evaluated by looking for the amount of time since each machine has last reported to database 108. By recording the heartbeat reporting time interval, we will be able to compare the length of time since each machine's last message against its expected next report based on the established regular reporting time interval. Overdue intervals will be queried and reported to the appropriate person who is responsible for the machine. The system will format an email message including the specific error, the reason for the error, if known and any errors common to any other network associated machine in step 208. The email is sent with the message detail on a machine by machine basis to the appropriate registered personnel in step 210.

Machines 100 that are determined to be overdue for a call home will cause the automated process at step 210 to contact a plurality of registered parties including support personnel. In certain cases, a machine may not be registered to any party. In that case, no one will be alerted that an expected communication entry is missing. In other cases, a single party will have registered to monitor the machine and will be alerted of the missing or problematic transmission. In a third case, the machine will appear in multiple registries being monitored by multiple parties. In this case, the alerts will need to be sent to various unrelated parties across registries. The automated alerting mechanism is able, given a machine, to determine who, if any one needs to be contacted from a dynamically generated set of registered users at step 210. Users are able to opt in and out of monitoring any number of machines at any time and the alerting mechanism is able to handle the distribution of alerts to a dynamically changing registry of concerned parties.

In evaluating field units or networked machines 100 for inactive status, the method, apparatus and computer code of the present invention considers the particular configuration of each machine reporting. Given a machine's configuration, such as stand-alone versus networked attached, a different method for determining inactive status may be used. The present invention is able to decide from among a plurality of criteria for being overdue or inactive in evaluating each machine. If a heartbeat or call home interval is changed to allow for a longer or shorter period of time as determined by the process described above, the system will detect this change in the heartbeat or call home interval and will now use this new interval as the assessment for the machines status. Machines on a network may have call home or heartbeat intervals which range from one to fourteen (14) days. The system accounts for these variations and determines the status of each machine as modified through the iteration process of the present invention.

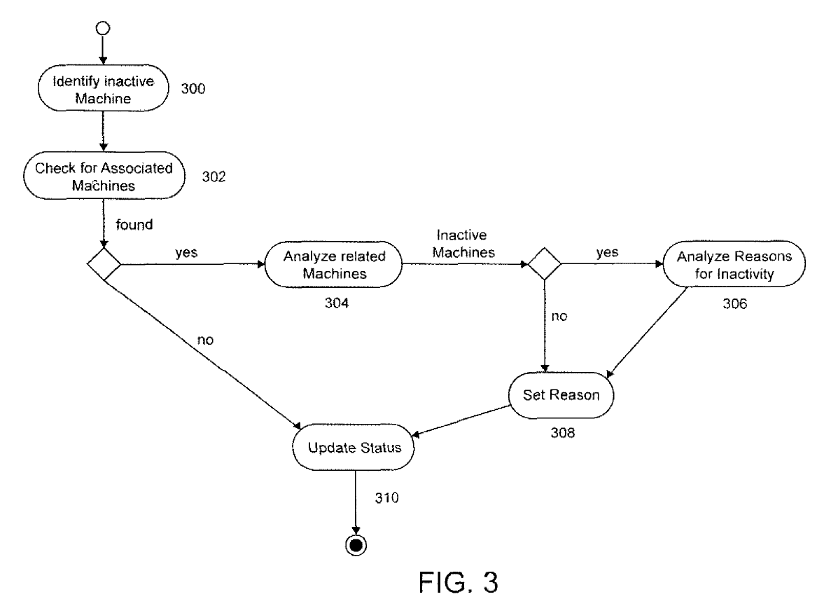

The method, apparatus and computer code of the present invention runs a script at a given interval to check the database 108 for the state or status of all machines 100. Referring to FIG. 3, the database 108 is updated starting with the first step of identifying the inactive machines at step 300. In step 302, the status or state of each machine on the network is checked to determine if the state of any machine has changed since the last check was made. In addition, in step 302 a check is made for any new machines that may have been added to or associated with the network for the first time. If new associated machines are found then they are analyzed in step 304 along with all networked machines 100 to determine if any machine is inactive. If any machine 100 on the network, including any new associated machine, is found to be inactive in step 304 then the reason for such inactivity is analyzed in step 306 and set or captured for update in step 308. If any network machine 100 or any new associated machine is found not to be active, then the reason for the machine's current state is alternatively set or captured for update in step 308. All of the machines on the network will now have a current state or status and this state is reflected through an update to the central apparatus or database in step 310.

As the list of inactive machines increases, it becomes important to manage the number of machines that are set to an inactive state. The list of inactive machines will hold historic data relating to the inactive machines that have stopped calling home for any reason.

The method, apparatus and computer code of the present invention will also use network intelligence to check with other systems to ensure that the list is accurate. For example, it will check with outside databases and compare state or status with other networked machines to determine the validity and reason for the status as reported (see FIG. 3, steps 304, 306 and 308). The present invention can, through the use of network intelligence, decide between methods for determining status based on the unique properties of the networked machines 100 which are evaluated at steps 304, 306 and 308 in FIG. 3. By identifying which machines have inactive status the method, apparatus and computer code of the present invention will be able to compare and identify a common source for a given problem which may be universal to one or more machines on the network. From such data conclusions concerning the state or error of a given machine or a given group of machines may be arrived at and transmitted to a particular user or user group. For example, if multiple machines are reporting the same problem and they are on a common network path or hub; or if there is only a report of a single failed machine indicating that the error or problem is isolated to a single instance on a single machine.

The following code sample provides one example of the steps and features of the present invention as claimed herein:

```
Stat_run.ksh
In an infinite loop:
  See if the stop file is present:
  If so: quit the program
  Print the time that program is started for log records
  Nohup the status check program (statusUpdate.sh)
  Remove the tmp log file that statusUpdate.sh produces
  Wait one day to run again.
End of infinite loop
StatusUpdate.sh
Print start time
Set flags for send email and remove files for testing and production
Set the db2 profile so you can connect to the database
Get a list of new machines that are not in the callhomestatus table
Get a list of inactive machines and machines that do not have a call home
Get a list of changed to Inactive Status
---- Building db2 commands ----
Format inserting of new machines into the database
Update Status to “Active” for all machines.
```

Format update statements to account for the inactive machines and machines without the call home status interval

Run script to format the emails and send them

Remove the list of new, inactive, changed to inactive machines and machines without a call home period to ensure the accuracy.

Print end time

The steps and computer code shown in FIGS. 2 and 3 are described with respect to processes in the distributed system of FIG. 1. It will be apparent to one of ordinary skill in the art, however, that the method steps and computer code shown in FIGS. 2 and 3, and the sample code above are applicable to distributed systems having a variety of configurations and monitoring a variety of processes. The method and computer code shown in FIGS. 2 and 3, and the sample code as detailed and described above, may also be performed by a process facilitating a service or performed by a separate process executed on a host in a distributed system.

The method, apparatus and computer code of the present invention may be performed by a computer program. The computer program can exist in a variety of forms both active and inactive. For example, the computer program can exist as software possessing program instructions or statements in source code, object code, executable code or other formats; firmware program(s); or hardware description language (HDL) files. Any of the above can be embodied on a computer readable medium, which include storage devices and signals, in compressed or uncompressed form. Such computer readable storage devices include conventional computer RAM (random access memory), ROM (read only memory), EPROM (erasable, programmable ROM), EEPROM (electrically erasable, programmable ROM), and magnetic or optical disks or tapes. Computer readable signals, whether modulated using a carrier or not, can include heartbeat data packages, error data packages, test data packages and the like, all described above. It will be understood by those skilled in the art that a computer system hosting or running the computer program can be configured to access a variety of signals, including but not limited to signals downloaded through the Internet or other networks. Such may include distribution of executable software program(s) over a network, distribution of computer programs on a CD ROM or via Internet download and the like.

The invention has been described with reference to preferred implementations thereof but it will be appreciated that variations and modifications within the scope of the claimed invention will be suggested to those skilled in the art. For example, the invention may be implemented on networks including ethernet, token ring and the like or used to control other aspects of a system. The method, apparatus and computer code of the present invention may be extended to monitor other devices which exhibit a plurality of operational modes.

While this invention has been described in conjunction with the specific embodiments thereof, it is evident that many alternatives, modifications and variations will be apparent to those skilled in the art. Any such changes may be made without departing from the spirit and scope of the invention.

What is claimed is:

1. A method for monitoring a plurality of computers on a network and for obtaining a state of each of said plurality of computers, each of said plurality of computers being coupled to a database, said method further comprising the steps of:
obtaining a current state of each of the plurality of computers,
determining if a new computer has been connected to the network and setting the current state for said new computer,
determining if the current state of any one of the plurality of computers has not been obtained within a prescribed interval of time,
determining if any one of the plurality of computers is in an inactive state,
determining if any one of the plurality of computers has changed to an inactive state,
updating the database to reflect the current state of each of the plurality of computers,
determining a list of users to be notified of the current state of each of the plurality of computers,
determining a reason for a change in the current state of each of the plurality of computers, and
notifying said list of users of the current state of each of the plurality of computers.

2. The method of claim 1 wherein the step of obtaining a current state of each of the plurality of computers includes the step of each of the plurality of computers sending a signal to the database at a predetermined time interval.

3. The method of claim 2 wherein the step of each of the plurality of computers sending a signal to the database at a predetermined interval includes the step of detecting when one or more of the plurality of computers is not properly communicating with the database.

4. The method of claim 1 wherein the step of notifying said list of users of the change in the current state of each of the plurality of computers includes the step of sending an automated alert to said list of users.

5. The method of claim 1 wherein the step of notifying said list of users of the change in the current state of each of the plurality of computers includes the step of sending an automated formatted email to said list of users.

6. The method of claim 1 wherein the step of notifying said list of users of the change in the current state of each of the plurality of computers includes the step of determining a subset of the plurality of computers and determining a subset of users from said list of users to notify.

7. The method of claim 1 wherein the step of determining a reason for a change in the current state of each of the plurality of computers includes the step of checking an outside database to determine the reason for any change in state of each of the plurality of computers.

8. The method of claim 1 wherein the step of determining a reason for a change in the current state of each of the plurality of computers includes the step of comparing one of the plurality of computers to another of the plurality of computers to determine the reason for any change in state of each of the plurality of computers.

9. An apparatus for monitoring a plurality of computers connected to a network and for notifying a database of a current one of a plurality of states of each of said plurality of computers, each of said plurality of computers being coupled to said database, comprising:
a network connection for obtaining the current state of each of the plurality of computers,
an interface to determine if a new computer has been connected to the network and setting the current state for said new computer,
an interface to determine if any one of the plurality of computers has not notified the database of the current state within a prescribed interval of time,
an interface to determine if any one of the plurality of computers is in an inactive state,
an interface to provide an update signal to the database to reflect the current state of each of the plurality of computers,
an interface to determine a list of users to be notified of a change in state of one of the plurality of computers, and
an interface to determine a reason for the change in state of one of the plurality of computers.

10. The apparatus of claim 9 wherein the network connection for obtaining the current state of each of the plurality of computers includes an interface for sending a signal to the database at a predetermined time interval.

11. The apparatus of claim 10 wherein the interface for sending a signal to the database at a predetermined time interval includes an interface for detecting when one or more of the plurality of computers is not operating correctly.

12. The apparatus of claim 9 further comprising an interface for automatically notifying said list of users.

13. The apparatus of claim 9 further comprising an interface for sending an automated formatted email to said list of users.

14. The apparatus of claim 12 wherein the interface for automatically notifying said list of users includes an interface for determining a subset of the plurality of computers and notifying a subset of users from said list of users.

15. The apparatus of claim 9 wherein the interface to determine the reason for any change in state of each of the plurality of computers includes an interface for checking within the network to determine the reason for a change in state of each of the plurality of computers.

16. The apparatus of claim 9 wherein the interface to determine the reason for any change in state of each of the plurality of computers includes an interface for checking outside the network to determine the reason for a change in state of each of the plurality of computer.

17. A computer program product for monitoring a plurality of computers on a network and for notifying a database of a state of each of said plurality of computers connected to the network, said computer program product comprising:
a computer usable medium having computer readable program code means embodied in said medium for obtaining a current state of each of the plurality of computers,
a computer usable medium having computer readable program code means embodied in said medium for determining if a new computer has been connected to the network and setting the current state for said new computer,
a computer usable medium having computer readable program code means embodied in said medium for determining if any one of the plurality of computers has not notified the database of the current state of said one of the plurality of computers within a prescribed interval of time,
a computer usable medium having computer readable program code means embodied in said medium for determining if any one of the plurality of computers is in an inactive state,
a computer usable medium having computer readable program code means embodied in said medium for updating the database to reflect the current state of each of the plurality of computers,
a computer usable medium having computer readable program code means embodied in said medium for determining a list of users to be notified of a change in state of each of the plurality of computers,
a computer usable medium having computer readable program code means embodied in said medium for determining a reason for the change in state of each of the plurality of computers, and
a computer usable medium having computer readable program code means embodied in said medium for automatically notifying said list of users of the change in state and the reason for the change in state of any of the plurality of computers.

18. The computer program product of claim 17 wherein the computer usable medium having computer readable program code means embodied in said medium for determining a reason for the change in state of each of the plurality of computers includes computer readable code means for checking a database within the network to determine the reason for the change in state of each of the plurality of computers.

19. The computer program product of claim 17 wherein the computer usable medium having computer readable program code means embodied in said medium for determining a reason for the change in state of each of the plurality of computers includes computer readable code means for checking a database outside the network to determine the reason for the change in state of each of the plurality of computers.

20. The computer program product of claim 17 wherein the computer usable medium having computer readable program code means embodied in said medium for determining if any one of the plurality of computers is in an inactive state includes computer readable program code means embodied in said medium for determining if any one of the plurality of computers has changed to an inactive state.
